(19) United States
(12) Patent Application Publication
(10) Pub. No.: US 2005/0021392 A1
(43) Pub. Date: Jan. 27, 2005

(54) Methods for facilitating private funding of early-stage companies

(76) Inventors: Kurt E. English, Newport Beach, CA (US); James W. Casparie, Anaheim, CA (US); John P. Garcia, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/663,193

(22) Filed: Sep. 16, 2003

Related U.S. Application Data
(63) Continuation of application No. 09/655,581, filed on Sep. 6, 2000, now abandoned.
(60) Provisional application No. 60/154,519, filed on Sep. 16, 1999.
(60) Provisional application No. 60/217,774, filed on Jul. 12, 2000.

(51) Int. Cl. G06F 17/60

(52) U.S. Cl. 705/12

(57) ABSTRACT

A consultant provides services to participants seeking involvement in early-stage companies, as well as to early-stage companies seeking the involvement of participants. The participants, typically known as angels, generally seek to provide early-stage funding sought by the companies in exchange for equity interests in the companies. The consultant identifies a company and presents the company to several participants. The participants, in turn, have the opportunity to accept a conditional offer by the consultant to perform a due diligence review of the company. The due diligence review is intended to provide the participants a basis for deciding whether to invest in the company. A participant preferably accepts the offer by casting a vote in favor of having the consultant perform the review. If a sufficient number of participants cast votes in favor of performing the review, the consultant accepts up to a maximum number of votes, performs the review, and charges each of the participants whose votes are accepted for a portion of the cost of the review. The results of the review are preferably provided first to those participants whose votes are accepted and subsequently to the remaining participants. The right to receive the results of the review in advance of others acts as an incentive for a participant to offer/vote to pay, in part, for a review of a company. The consultant preferably also negotiates an additional incentive from the company in the form of an equity interest in the company that is shared among the participants whose votes are accepted.

### RELATED APPLICATION INFORMATION

This application is a continuation of U.S. application Ser. No. 09/655,581, Filed Sep. 6, 2000, which claims the benefit of U.S. Provisional Application No. 60/154,519, Filed Sep. 16, 1999 and U.S. Provisional Application 60/217,774, Filed Jul. 12, 2000.

### FIELD OF THE INVENTION

This invention relates generally to facilitating the due diligence review and funding of early-stage companies and, more particularly, the invention relates to methods for introducing companies to potential sources of funding and for providing due diligence reviews of the companies to potential sources of funding.

### DESCRIPTION OF THE RELATED ART

In the Unites States of America, approximately $50 billion is invested every year by private individuals, otherwise known as angels, in early-stage, entrepreneurial companies. See Forbes ASAP, Jun. 1, 1998. Some angels, possibly due to the fact that they are private individuals, typically lack the time, desire, or experience required to make well-considered and informed investment decisions. As a result, many investments are lost and/or perform below expectations. Furthermore, the lack of general organization of this group of investors makes access relatively difficult for companies seeking investment. The present invention seeks to facilitate the process of both due diligence and angel funding for both angel investors and for companies seeking funding.

### SUMMARY OF THE INVENTION

In a preferred embodiment of the present invention, a consultant provides services to participants seeking involvement in early-stage companies, as well as to early-stage companies seeking the involvement of participants. The participants, typically known as angels, generally seek to provide early-stage funding sought by the companies in exchange for equity interests in the companies. The consultant preferably provides due diligence reviews of the companies to the participants and introduces the participants and the companies.

In a preferred method, the consultant identifies a company and presents the company to several participants. The consultant presents to the participants a conditional offer to perform a due diligence review of the company. The offer is preferably presented in the form of an opportunity to vote in favor of having the consultant perform the review. The due diligence review is intended to provide a basis for the participants to decide whether to invest in the company. A participant preferably accepts the offer by casting a vote in favor of having the consultant perform the review. If a sufficient number of participants cast votes in favor of performing the review, the consultant accepts up to a maximum number of votes, performs the review, and charges each of the participants whose votes are accepted for a portion of the cost of the review. The results of the review are preferably provided first to those participants whose votes are accepted and subsequently to the remaining participants. The right to receive the results of the review in advance of others acts as an incentive for a participant to vote (effectively offering to pay, in part) for a review of a company.

In the preferred method, the consultant provides to the company very valuable access to the consultant's network of participants. In exchange, the consultant is preferably able to negotiate from the company a reassignable right to purchase an equity interest in the company. For example, the consultant may obtain the right to purchase, at the most recent selling price, 20% of the shares of a company on a fully diluted basis. For early-stage companies, the most recent selling price of company stock is typically a substantially discounted price.

In the preferred method, the consultant uses a portion of the right to purchase company stock to provide an additional incentive for the participants to vote or offer to pay for a review of a company. For each participant whose vote is accepted, the consultant preferably instructs the company to assign some equity interest to the participant under the consultant's right to purchase. The opportunity to acquire an equity interest in a company at a substantially discounted price acts as the additional incentive for a participant to offer to pay for a review of a company.

In a preferred system, the consultant preferably maintains a host computer system through which the consultant performs portions of the preferred method. The host computer system preferably hosts a web site through which the companies and the participants can interact with the consultant.

### BRIEF DESCRIPTION OF THE DRAWINGS

FIG. 1 illustrates the various entities and the key exchanges between the entities in accordance with a preferred embodiment of the invention.

FIG. 2 illustrates a general method of the present invention at an overview level.

FIGS. 3A and 3B illustrate a preferred method of the present invention.

FIG. 4 illustrates a system in conjunction with which the methods are preferably performed.

### DETAILED DESCRIPTION OF THE EMBODIMENTS

In the following description, reference is made to the accompanying drawings, which form a part hereof, and which show, by way of illustration, specific embodiments or processes in which the invention may be practiced. Where possible, the same reference numbers are used throughout the drawings to refer to the same or like components. In some instances, numerous specific details are set forth in order to provide a thorough understanding of the present invention. The present invention, however, may be practiced without the specific details or with certain alternative equivalent devices and methods to those described herein. In other instances, well-know methods and devices have not been described in detail so as not to unnecessarily obscure aspects of the present invention.

I. Overview

FIG. 1 illustrates the various entities and the key exchanges between the entities in accordance with a preferred embodiment of the invention. Several companies 100 seeking early-stage funding, other capital, strategic partnerships, sales channels, or expertise are illustrated. Each of the companies 100 is a business entity that is preferably, but not necessarily incorporated. A company 100 may be, for example, a corporation, a partnership, a sole proprietorship, a limited liability company, a limited liability partnership, or a limited partnership. Several participants 110 seeking to invest in or participate in companies are also illustrated. The participants 110 may be individuals, business entities, or even non-business entities, such as trusts. In the preferred embodiment, the participants 110 are accredited or unaccredited investors, typically known as angel investors, permitted by law to invest in early-stage companies. The participants 110 may alternatively or additionally be investors other than angel investors. A participant 110 may alternatively or additionally seek to actively participate in the companies, such as, by acting on a board of directors or advisory board, acting as an officer, or becoming an employee. Participants 110 may also or alternatively seek to establish strategic partnerships with or sales channels to, from, or through the companies. In the preferred embodiment, a consultant 120 provides services to both the companies 100 and the participants 110 to facilitate the investment process or a relationship. The consultant 120 is preferably a business entity such as a corporation, partnership, sole proprietorship, limited liability company, limited liability partnership, or limited partnership. In one embodiment, the consultant 120 may also be a participant 110.

The consultant 120 provides the companies 100 with participant introductions. The consultant 120 preferably has contacts with multiple and preferably numerous participants 110 that may potentially provide funding to the company 100. The consultant 120 also preferably provides corporate expertise to the companies 100. The consultant 120 may act as a mentor for the companies 100 and preferably employs or engages personnel with experience and knowledge that will increase the chances of the companies' success. In accordance with the preferred methods described below, the consultant 120 performs one or more reviews of the company 100. The consultant 120 preferably includes the findings of a review in a report. The reviews are preferably due diligence reviews, in which case the results of a review are included in a due diligence report. A review may, however, by any type of review. These reports are preferably provided to the participants 110 to assist the participants in making investment decisions, decisions on whether to join a company, or other involvement decisions. A report may also be provided to the company 100 that is the subject of the report.

Since the consultant 120 provides to the company 100 very valuable access to the consultant's network of participants 110, the consultant 120 is preferably able to negotiate from the company 100 some value in return. In the preferred embodiment, the consultant 120 negotiates a reassignable right to purchase an equity interest in the company 100. For example, the consultant may obtain the right to purchase, at the most recent selling price, 20% of the shares of a company on a fully diluted basis. For early-stage companies, the most recent selling price of company stock is typically a substantially discounted price. The consultant 120 may alternatively or additionally negotiate an actual equity interest itself rather than the right to purchase. The equity interest may be, for example, stock, stock options, bonds, or debentures. As an alternative to providing an equity interest in the company 100, the company 100 may pay the consultant 120 for its services.

The consultant 120 preferably also provides several valuable services to the participants 110. One service provided by the consultant 120 is introducing the participants 110 to companies 100. An introduction may be in the form of an informative e-mail, a listing on a web site hosted by the consultant 120, a mailed flyer, or any other applicable device or method for providing information about a company 100 to the participants 110.

For each company 100 that is presented to the participants 110, the consultant 120 preferably organizes a vote in which some or all of the participants 110 have the opportunity to cast votes in favor of performing a review of the company 100. If a sufficient number of votes are cast in favor of performing the review, the consultant 120 performs the review the company 100. The consultant 120 preferably also accepts some or all of the votes cast.

Acceptance of a vote by the consultant 120 preferably requires the participant 110 who cast the accepted vote to compensate the consultant 120 for at least a portion of the cost of the review. In return, the consultant's acceptance of a vote preferably entitles the participant 110 to two benefits. First, an acceptance of a vote entitles the participant 110 to receive the due diligence report in advance of or even to the exclusion of those participants 110 whose votes were not accepted, or those participants 110 who did not vote in favor of performing the review, or who fail to meet some other criteria. Second, an acceptance may entitle the participant 110 to receive a voting incentive from the company 100. The incentive is preferably an equity interest in the company 100, such as stock, stock options, or stock discounts. The obligations of the consultant 120 and the participants 110 are preferably incorporated into an agreement between the consultant 120 and each participant 110 and/or a company.

FIG. 1 illustrates the transfer of the voting incentives or equity interest from the company 100 directly to the participants 110. The consultant 120 preferably exercises a portion of its right to purchase in order to cause the company 110 to transfer or sell some equity interest to the participants from which votes are accepted. In one alternative embodiment the voting incentives are transferred in accordance with an agreement between the consultant 120 and the company 100 that requires the company 100 to provide the incentives directly to those participants 110 from which votes have been accepted. In another alternative embodiment, the voting incentives, such as stock or stock options in the company 100, may be first transferred from the company 100 to the consultant 120. The consultant 120 can then transfer the incentives to the participants 110 from which votes are accepted.

At any point in time after the introduction of the company 100 to the participants 110, the participants 110 have the opportunity to invest or participate in the company 100. Typically, a participant 110 will provide funding, such as cash or a bridge loan, in exchange for an equity interest in the company, such as stock, stock discounts, or stock options. The participant 110 may, however, offer to provide a service to the company 110, such as acting as an officer, a member of the board of directors, or an employee. The participants 100 preferably, but need not, choose to wait until they have received due diligence reports on the company 100 before making investment and/or participation decisions.

FIG. 2 illustrates a general method 200 of the present invention at an overview level. The method 200 provides for two due diligence reviews of each company. A summary review is a short due diligence review process of the company at issue. The summary review is preferably detailed enough to provide a basis for determining whether a more extensive review of the company is worthwhile. The summary review preferably involves from 8 to 40 man-hours of effort. A detailed review is an exhaustive due diligence review of the company. The detailed review is intended to provide a basis for determining whether an investment in the company is warranted. The detailed review preferably involves from 100 to 240 man-hours of effort.

At a step 202 of the method 200, the consultant presents a company to the participants. At a step 204, the consultant receives a sufficient number of votes to perform a summary due diligence review of the company. At a step 206, the consultant performs the summary review of the company. At a step 208, the consultant receives a sufficient number of votes to perform a detailed due diligence review of the company. At a step 210 the consultant performs a detailed review of the company. At a step 212, each participant, after reading the detailed review, preferably decides whether to invest and/or participate in the company.

In alternative embodiments, fewer or more reviews covering various aspects of the company may be used. The number and content of the reviews may be varied based upon the complexity of the issues at stake and the needs of the participants involved.

II. Preferred Method

FIGS. 3A and 3B illustrate a preferred method 300 of the present invention. The preferred method 300 is similar to the general method 200, but includes additional detail.

At a step 302, the consultant preferably receives a prepaid retainer from each of the participants. The retainer is preferably collected on an annual basis and establishes a person or entity as a participant for the year. A participant is preferably eligible to receive the services of the consultant. As the participant receives services from the consultant, the consultant preferably charges fees against the retainer. The participant may also supplement the retainer as necessary. The consultant can also charge or bill the participant for additional services if the retainer is completely used up. In the preferred embodiment, a payment of $15,000 to $100,000 is collected from each participant on an annual basis. The participant preferably forfeits any amount of the retainer that is unused at the end of the year. In conjunction with the consultant's receipt of the retainer, the consultant and a participant preferably enter into an agreement defining the obligations of each party regarding the payment for accepted votes, distribution of due diligence reports, and allocation of voting incentives.

At a step 304, the consultant identifies a company seeking funding and/or participation. In some instances, the company may approach the consultant as a result of the consultant's marketing efforts. The consultant may also seek out and find companies through research. Alternatively, the company may be introduced to the consultant. For example, one of the participants may introduce the company to the consultant. A third party may also introduce the company to the consultant.

At a step 306, the consultant performs an initial review of the company to determine whether to present the company to the participants. If the consultant chooses not to present the company to the participants, the method 300 terminates. In this case, the consultant may choose, for example, to incubate the company without the assistance of the participants. If the consultant chooses to present the company to the participants, the method proceeds to the next step.

At a step 308, the consultant obtains a reassignable right to purchase an equity interest in the company. The equity interest in the company may be, for example, stock, stock options, or stock discounts. Later in the method 300, the consultant preferably uses a portion of its right to purchase in order to cause the company to transfer or sell some equity interest to the participants from which votes are accepted. This equity interest is preferably one of the incentives for the participants to vote in favor of performing a review. The consultant may also use or transfer a portion of the right to purchase to reward an individual or entity for introducing the company to the consultant. The consultant may also use or sell a portion of the right to purchase to obtain services it may need in conducting its business. The consultant may also use or assign a portion of the right to purchase to benefit its owners, partners, principals, or employees in accordance with its business objectives.

The consultant and the company preferably enter into an agreement to effect the step 308. The agreement negotiated by the consultant may include, for example, a reassignable right to purchase, at the most recent selling price, 20% of the outstanding shares in a company on a fully diluted basis. For early-stage companies, the most recent selling price of company stock is typically a substantially discounted price. The consultant and the company may negotiate various additional terms into the agreement in order to handle the cases in which not enough votes are received to support summary or detailed reviews. The consultant and the company may also negotiate for other value to be exchanged.

The consultant preferably uses the right to purchase to cause the company to sell shares to several entities or participants. For example, the consultant may cause the shares to be sold, at the discounted price, as shown in the following table:

| | |
|---|---|
| 1% | To entity or person introducing company to consultant |
| 2% | Total to 10 participants whose votes in favor of a summary review |
| | are accepted |
| 7% | Total to 10 participants whose votes in favor of a detailed review |
| | are accepted |
| 10% | To consultant as compensation for consultant's services to |
| | company |

Alternatively, the consultant may sell or trade the reassignable right to purchase rather than exercising it.

At the step 308, the consultant may alternatively or additionally negotiate an agreement providing for the allocation of incentives to the participants. The agreement preferably requires that the company provide some equity interest to the participants whose votes are accepted. The consultant may alternatively or additionally negotiate an actual equity interest itself rather than the right to purchase. The equity interest may be, for example, stock, stock options, bonds, or debentures. The equity interest may then be transferred to participants as an incentive.

At a step 310, the consultant presents or introduces the company to the participants. The consultant may send to each participant an e-mail containing information on the company. The information preferably includes information about the company's management team, the industry, the market, the product or service, the competitive environment, the company's capitalization, and the company's finances. The consultant may list the information about the company on a web site. The consultant may send the information to the participants in a mailed package or envelope. The consultant may alternatively schedule a live or recorded presentation. Indeed, any applicable communications medium may be used to present the company to the participants.

At a step 312, the consultant presents the participants with the option of casting votes in favor of performing a summary review of the company presented. In presenting the option, the consultant preferably identifies a minimum number of votes it seeks in order to perform the summary review. In the preferred embodiment, the option of casting votes for a summary review is presented simultaneously with the introduction of the company in the step 310. Alternatively, the option of casting votes may be presented separately, such as in a separate communication. In the preferred embodiment, for each company presented, a participant may either abstain or cast a vote in favor of performing a review. A participant may also be allowed to cast more than one vote in favor of performing a review. In alternative embodiments, participants may be allowed to cast votes against performing reviews.

At a step 314, the consultant receives the summary review votes. The participants may cast the votes through a web site, via e-mail, via facsimile, via regular mail, over the phone, or through any other applicable method. The consultant preferably sets a limited time period, such as one week, during which votes may be received.

At a step 316, the consultant determines that a minimum number of votes have been cast in favor of performing the review. The consultant preferably chooses a minimum number of votes necessary to perform a review, counts the votes, and determines whether the minimum number has been received. In the preferred embodiment, a number of votes, such as 10, may be required. The choice of the minimum number may be based upon factors such as the estimated cost of the review. If the minimum number of review votes have been cast, the method proceeds to the next step. In one embodiment, the consultant may also cast votes.

In one embodiment, if at least a minimum number of summary review votes are not received, the method 300 terminates. In this case, the consultant may choose to discontinue its relationship with the company. Alternatively, the consultant may choose to continue a separate relationship with the company. The consultant may, for example, proceed with the review without receiving payment from the participants. The consultant may, for example, attempt to incubate the company in another manner. In another embodiment, the consultant may have the option to supply the necessary review votes itself, in which case the method proceeds to the next step.

At a step 318, the consultant prioritizes the summary review votes in the case that more votes are received than can be accepted. Any of several methods of prioritizing the received summary review votes may be used. The votes may be prioritized by order of receipt, from earliest to latest. The votes may be prioritized by participant according to the least or most recently accepted summary review vote for each participant. The votes may be prioritized by participant according to the least or most recently accepted detailed review vote for each participant. The votes may be prioritized by participant based upon the remaining amount of the participant's prepaid retainer. In one embodiment, the prepaid retainer may have an expiration date. In this case, the summary review votes may be prioritized by participant based upon the expiration date of the retainer.

At a step 320, the consultant accepts up to a maximum number of summary review votes. If more than the maximum number of summary review votes have been cast, the consultant accepts votes based upon the priority determined in the previous step.

At a step 322, the consultant charges the participants whose votes are accepted for the accepted votes. A participant may be charged, for example, $700 for each accepted summary review vote. In the case a participant has a balance remaining from his prepaid retainer, the cost of each vote can be charged against the retainer. In the case a participant has completely used the retainer, the consultant may, for example, charge a credit card provided by the participant, debit the participant's bank account, or bill the participant. The participant's payment for the accepted vote is preferably provided to compensate the consultant for the cost or effort of performing the review.

At a step 324, the consultant causes the voting incentives to be distributed to the participants from which votes have been accepted. In the preferred embodiment, the consultant uses its right to purchase to cause the company to sell shares to the participants at a discounted price. The consultant preferably informs the company of the identities of the participants from which votes have been accepted and the number of shares to be sold to each. In response, the company offers to sell the shares to the participants at the discounted price. For example, based upon an agreement between the consultant and the participants, the consultant may cause the company to offer to sell 0.2% of the company's stock at a discounted price to the participant who cast each accepted vote. In an alternative embodiment, the consultant first acquires the voting incentives from the company and then distributes the incentives directly to the participants. In the case that the consultant supplied some of the votes necessary to reach the minimum number of votes in the step 316, the consultant may also receive the incentives associated with the votes supplied.

At a step 326, the consultant performs a summary review of the company. In performing the review, the consultant may obtain information from the company and other sources, perform an analysis of the company based upon the information, and incorporate the information and analysis into a report. The review is preferably a due diligence review, but may be another type of review. In an alternative embodiment, the consultant may hire an outside expert or a third party to perform or assist in performing the review. The consultant may choose to compensate the outside expert or third party by assigning or executing a portion of the reassignable right to purchase acquired from the company. The consultant may alternatively assign a portion of the right to purchase to the outside expert or third party.

At a step 328, the consultant provides the summary review report to the participants whose votes have been accepted. The consultant may provide the report by any applicable method of communication, such as, for example, through a web site, e-mail, regular mail, facsimile, or direct delivery.

At a step 330, the consultant optionally provides the report to the remaining participants. In the step 330, the report may be provided at a later time or date than it is initially provided in the step 328. The receipt of the report at an earlier date as opposed to a later date or as opposed to not receiving the report at all preferably provides added value in exchange for the participant's payment for the accepted vote. This added value is preferably in addition to the incentive provided to the participant by the company. This value may, however, be provided instead of any incentive provided by the company, in which case the company may not need to provide any voting incentive.

At a step 332, the consultant optionally provides the report to the company. The report preferably represents some of the value provided to the company by the consultant in exchange for any equity interest or value provided by the company to the consultant. The company may choose to use the report, for example, as evidence of its worth when seeking additional investment capital.

The following steps 334 through 354 of the method 300 are preferably similar to the steps 312 through 332. These steps are therefore discussed in less detail than the steps 318 through 336, to avoid unnecessary repetition. It will be apparent to one skilled in the art that in general, the details suggested in conjunction with the steps described above will be applicable to the steps described below.

At a step 334, the consultant presents the participants with the option of casting votes in favor of performing a detailed review of the company presented. In presenting the option, the consultant preferably identifies a minimum number of votes it seeks in order to perform the detailed review. When providing the option, the consultant preferably refreshes the participant's recollection of the company by again providing the information originally provided in the step 310. The consultant may also provide additional information in conjunction with the option such as any findings or conclusions of the summary review.

At a step 336, the consultant receives the detailed review votes. At a step 338, the consultant determines that a minimum number of votes have been cast in favor of performing the review. In the preferred embodiment a minimum number of votes, such as 10, may be required. If the minimum number of review votes have been cast, the method proceeds to the next step. In one embodiment, if at least a minimum number of detailed review votes are not received, the method 300 terminates. In another embodiment, the consultant may have the option to supply the necessary review votes itself, in which case the method proceeds to the next step.

At a step 340, the consultant prioritizes the detailed review votes in the case that more votes are received than can be accepted. At a step 342, the consultant accepts up to a maximum number of detailed review votes based upon priority.

At a step 344, the consultant charges the participants whose votes are accepted for the accepted votes. A participant may be charged, for example, $5000 for each accepted detailed review vote. The participant's payment for the accepted vote is preferably provided to compensate the consultant for the cost or effort of performing the review.

At a step 346, the consultant causes the voting incentives to be distributed to the participants from which votes have been accepted. For example, based upon an agreement between the consultant and the participants, the consultant may cause the company to offer to sell 0.7% of the company's stock at a discounted price to the participant who cast each accepted vote.

At a step 348, the consultant performs a detailed review of the company. At a step 350, the consultant provides the detailed review report to the participants whose votes have been accepted. At a step 352, the consultant optionally provides the report to the remaining participants. In the step 352, the report may be provided at a later time or date than it is initially provided in the step 350. At a step 354, the consultant optionally provides the report to the company.

At a step 356, each participant decides whether to invest in, participate in, or become involved with the company that has been reviewed. The participants preferably use the information provided in the summary review and detailed review reports in making their decisions.

Some aspects of the preferred method 300 may also be described in a more general sense. Referring back to the steps 312 and 334, the consultant, by presenting the option to vote on performing the review, is effectively presenting the participants with an offer to provide a service of performing a review. The offer is, of course, a conditional offer conditioned upon a sufficient number of votes being received and upon the acceptance of the participant's vote. Upon these conditions being satisfied, the consultant agrees to perform a review and the participant whose vote is accepted agrees to pay the consultant effectively for a portion of the cost of the review. This transaction is effected, however, through the mechanism of voting, accepting votes, and paying for votes.

III. Related System

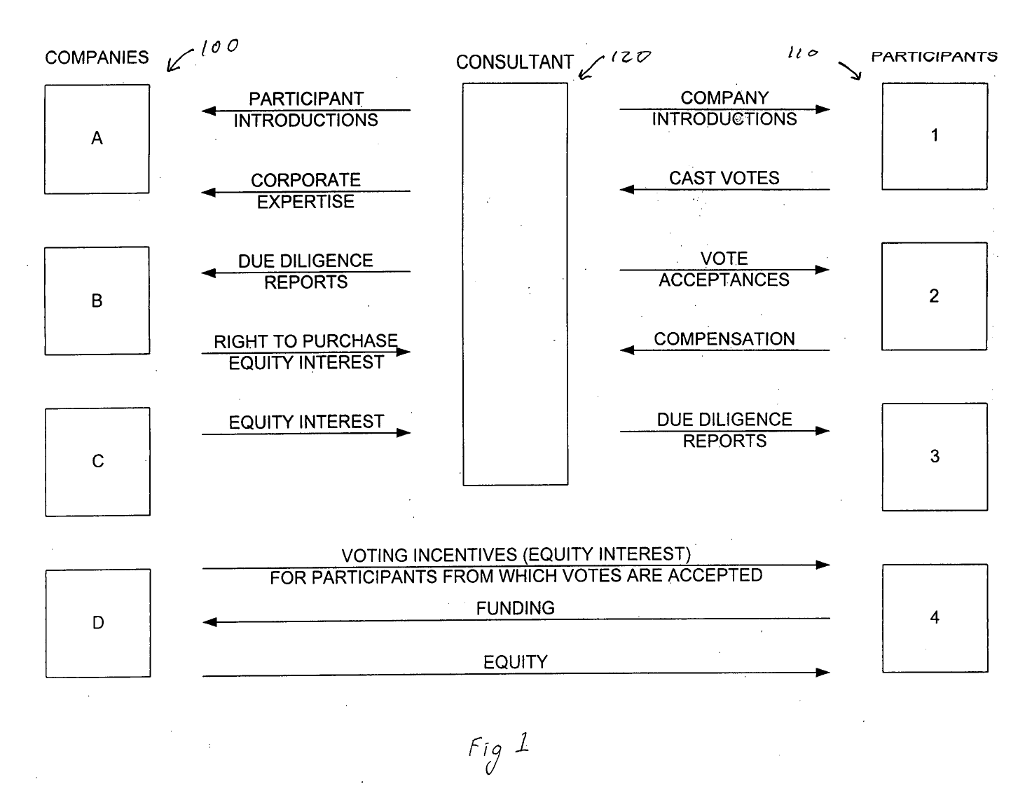

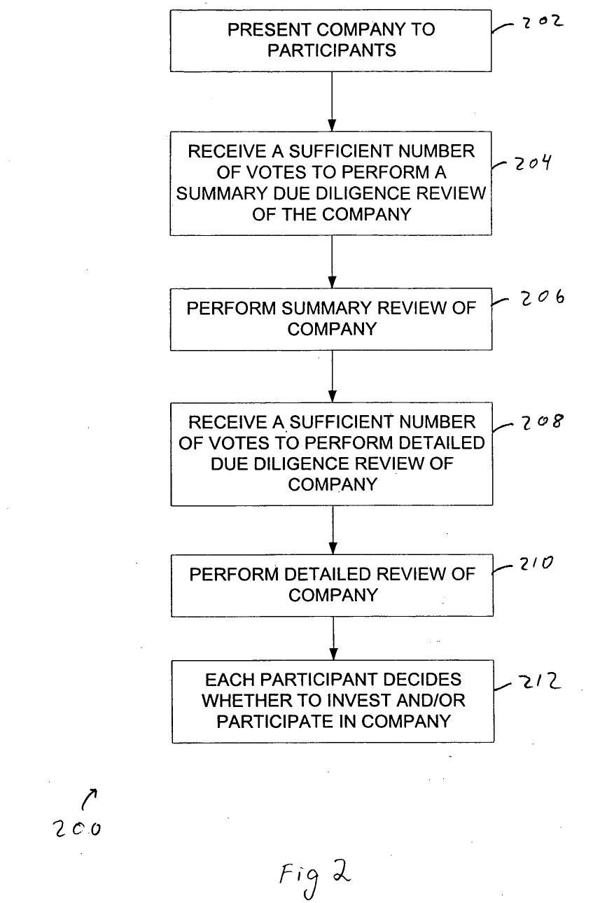

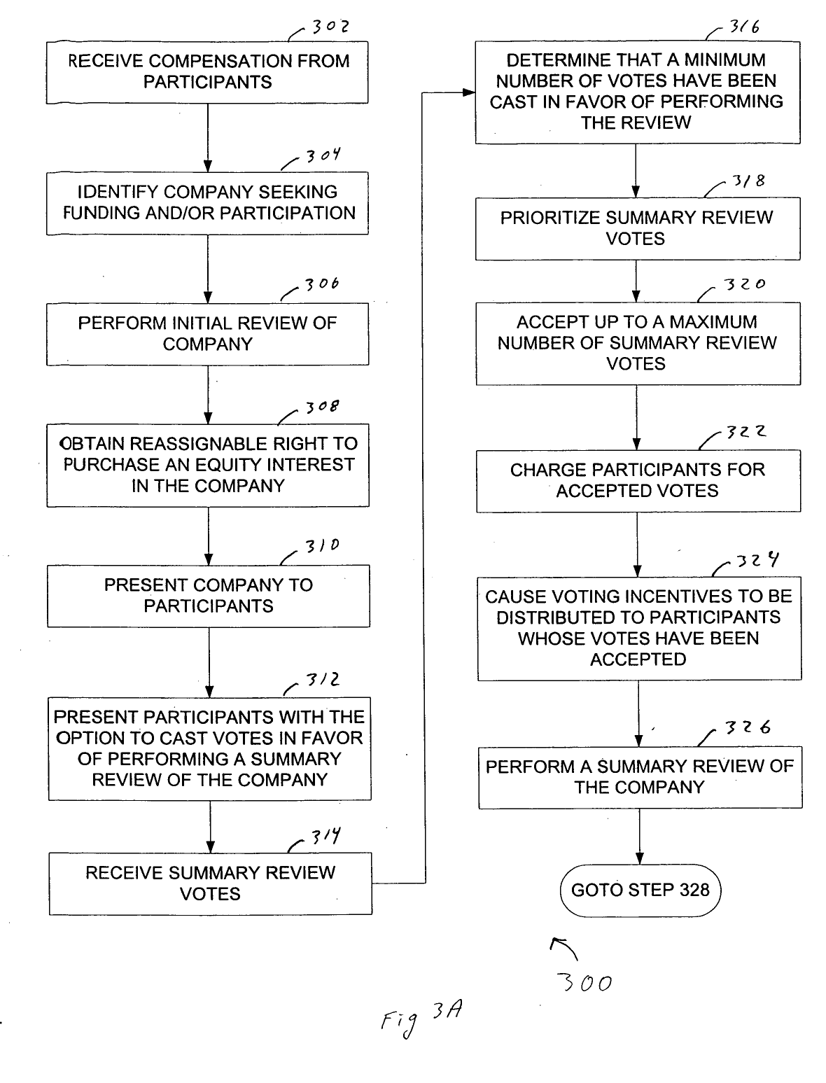

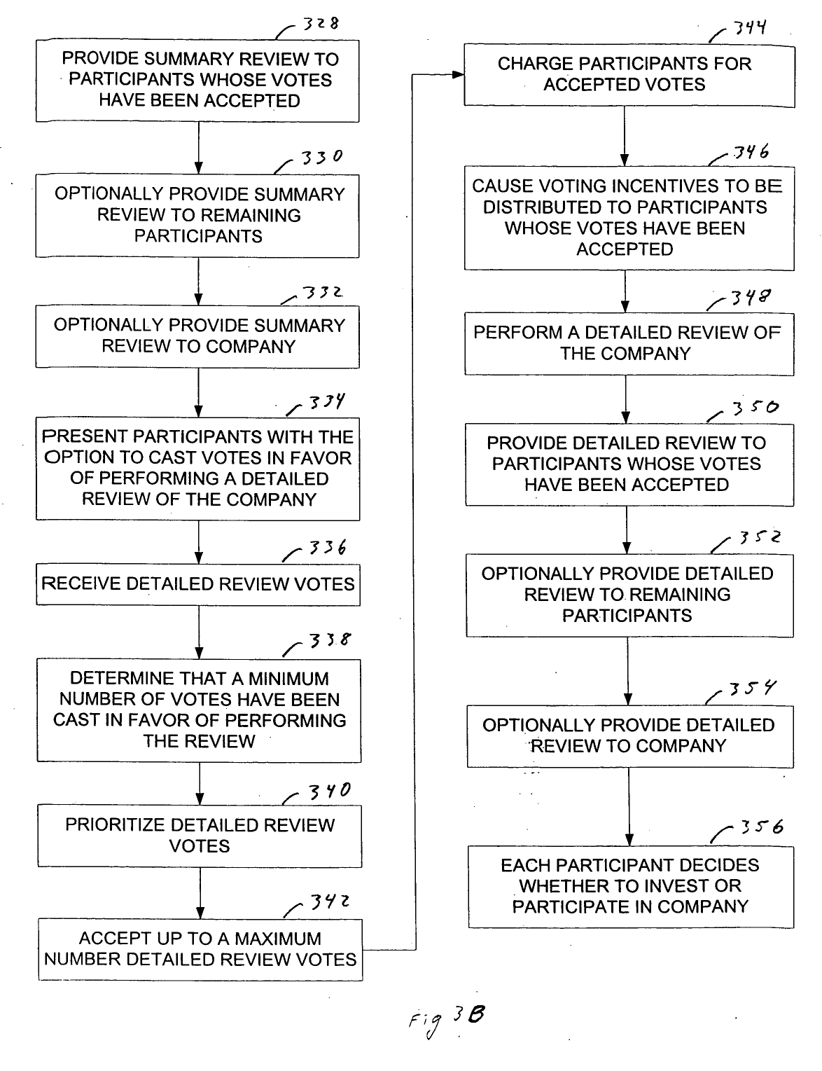

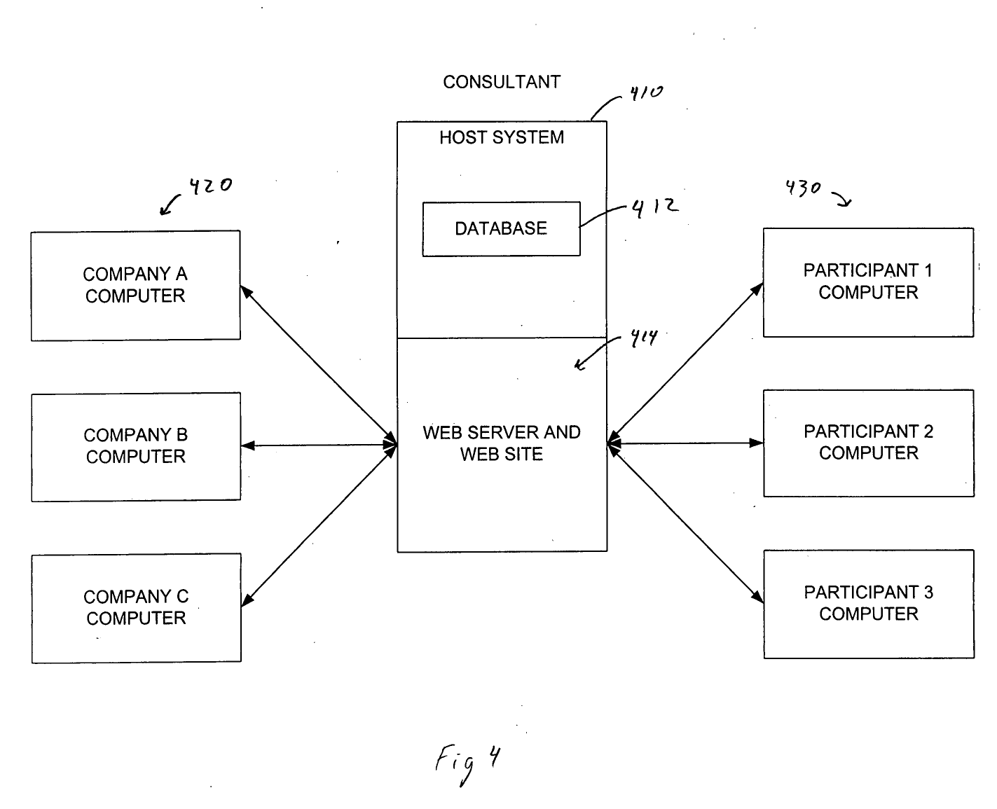

FIG. 4 illustrates a system 400 in conjunction with which the methods 200 (FIG. 2) and 300 (FIGS. 3A and 3B) are preferably performed. The consultant preferably maintains a host computer system 410 upon which it stores data and through which it interacts with companies and participants. The host system 410 preferably includes a database 412 and hosts a web server and web site 414. The database 412 is preferably used to store company information, such as, for example, contact information, information applicable to the review process, and possibly reports. The database 412 is preferably also used to store information for each participant such as, for example, contact information, number of ballots available, voting history, remaining balance for a prepaid retainer, credit card information, and billing information.

The companies preferably interact with the consultant through the host system 410 using a company computer 420. The company computer 420 may be any kind of computer capable of accessing the World Wide Web, such as, for example a personal computer. The companies preferably interact with the consultant through the web site 414. Alternatively, the companies may interact with the consultant through e-mail that may be received through the host system 410. Communication between the company computer 420 and the host system 410 is preferably effected through a computer network such as the Internet.

The participants preferably interact with the consultant through host system 410 using a participant computer 430. The participant computer 430 may be any kind of computer capable of accessing the World Wide Web, such as, for example a personal computer. The participants preferably interact with the consultant through the web site 414. Alternatively, the participants may interact with the consultant through e-mail that may be received through the host system 410. Communication between the participant computer 430 and the host system 410 is preferably effected through a computer network such as the Internet.

IV. Alternative and Additional Embodiments

In an alternative embodiment, the consultant performs reviews of a company substantially in exchange for an equity interest in the company or for other value preferably provided by the company. The consultant provides the reviews to the participants as a service to the company. In this case, payment by the participants and voting by the participants is not needed.

In another alternative embodiment, the consultant may sell or allocate ballots or the right to vote, to the participants. The ballots may be in any applicable form, such as a paper voting ballot, an electronic notice offering the opportunity to cast a vote, or a record in a database indicating that a participant has the right to vote on a review. The consultant can charge the participants for the ballots as an alternative to charging participants for accepted votes. The consultant can allocate, for example, 5 summary review ballots and 5 detailed review ballots to each participant in exchange for an annual payment. Each summary review ballot may be used to cast a vote in favor of performing a summary review of a company. Each detailed review ballot may be used to cast a vote in favor of performing a detailed review of a company. A participant may also purchase additional ballots in exchange for additional payment.

In this embodiment, a participant is only allowed to vote if the participant has a ballot. For a summary review vote, the participant must have a summary review ballot. For a detailed review vote, the participant must have a detailed review ballot. If the participant does not have a ballot, the participant may be allowed to purchase an additional ballot, which will allow the participant to cast a vote in favor of performing the review. A participant may alternatively be allowed to vote without a ballot. In this case, however, the participant may be required to purchase a ballot upon acceptance of the vote.

In another alternative embodiment, the consultant may choose not to set a maximum number of summary review votes. In this case, the consultant may accept all of the summary review votes cast. The consultant can set the cost of each accepted vote to reflect the number of votes accepted. The consultant may, for example, divide a total cost of a review by the number of votes cast in order to determine the amount to be charged for each accepted vote. The consultant may alternatively charge a fixed amount for each accepted vote regardless of the number accepted. The consultant can also adjust the incentive associated with each accepted vote to reflect the number of votes accepted. The consultant may, alternatively, provide a fixed incentive in response to each accepted vote.

In another alternative embodiment, the consultant may provide due diligence reviews of companies of its own choosing, without soliciting votes from the participants. In this embodiment, the consultant preferably receives an annual payment from each of the participants. The consultant then uses its best judgment to identify companies that are likely to be of interest to the participants. The consultant performs due diligence reviews of the identified companies and provides the results of the reviews to the participants.

V. Conclusion

Although the invention has been described in terms of certain preferred embodiments, other embodiments that will be apparent to those of ordinary skill in the art, including embodiments which do not provide all of the features and advantages set forth herein, are also within the scope of this invention. Accordingly, the scope of the invention is defined by the claims that follow. In the claims, a portion shall include greater than none and up to the whole of a thing. In method claims, reference characters are used for convenience of description only, and do not indicate a particular order for performing a method.

1. A method comprising:
receiving compensation from a plurality of participants;
presenting a business entity to the participants;
deciding, based at least upon a first vote of the participants, to perform a first review of the business entity; and
presenting the results of the first review to at least one of the participants that voted in favor of performing the first review.

2. The method of claim 1, further comprising:
deciding, based at least upon a second vote of the participants, to perform a second review of the business entity; and
presenting the results of the second review to at least one of the participants that voted in favor of performing the second review.

3. The method of claim 2, wherein the first review and the second review are due diligence reviews of the business entity.

4. A method comprising:
(A) receiving compensation from a plurality of participants;
(B) identifying a business entity; and
(C) causing the business entity to assign an equity interest in the business entity to at least one of the participants.

5. The method of claim 4, further comprising
obtaining from the business entity a right to purchase an equity interest in the business entity.

6. The method of claim 5, wherein (C) comprises exercising the right to purchase to the benefit of the at least one of the participants.

7. The method of claim 4, further comprising
causing value to be provided to the business entity.

8. The method of claim 7, wherein the value is provided in exchange for (C).

9. The method of claim 7, wherein the value comprises a service.

10. The method of claim 7, wherein the value comprises funds.

11. The method of claim 7, wherein the value comprises goods.

12. The method of claim 7, wherein the value comprises the results of a review of the business entity.

13. The method of claim 12, wherein the value further comprises the providing of the results to at least one of the participants.

14. The method of claim 7, wherein the value comprises the introduction of the business entity to the participants.

15. The method of claim 7, further comprising
providing the value to the business entity.

16. The method of claim 7, wherein the value is provided by a third party.

17. The method of claim 4, further comprising
obtaining an agreement from the business entity that the business entity assign an equity interest in the business entity to at least one of the participants.

18. The method of claim 4, further comprising
evaluating the interest of the participants in the business entity.

19. A method comprising:
receiving compensation from a plurality of participants;
identifying a business entity;
obtaining an equity interest in the business entity; and
transferring a portion of the equity interest to at least one of the participants.

20. A method comprising:
(A) identifying a plurality of participants;
(B) identifying a business entity;
(C) presenting to the participants, in conjunction with an identification of the business entity, the option to cast votes in support of an activity;
(D) receiving at least one vote cast in response to (C);
(E) accepting at least one received vote; and
(F) receiving compensation from at least one of the participants.

21. The method of claim 20, wherein the compensation is received from each of the participants that cast accepted votes.

22. The method of claim 21, wherein (F) is performed in association with (E).

23. The method of claim 20, wherein the compensation is in the form of a prepaid retainer.

24. The method of claim 23, further comprising
for each of the participants that cast accepted votes, deducting, in association with (E), an amount from the participant's prepaid retainer.

25. The method of claim 20, further comprising
providing, in association with (E), the results of a review of the business entity to the participants that cast accepted votes, wherein the review is the activity.

26. The method of claim 20, further comprising:
(G) determining that at least a minimum number of votes have been cast;
and
in response to (G), causing a review of the business entity to be performed, wherein the review is the activity.

27. The method of claim 26, further comprising:
providing the results of the review to the participants that cast accepted votes.

28. The method of claim 26, wherein the review comprises a due diligence review.

29. The method of claim 26, further comprising performing the review.

30. The method of claim 26, wherein a third party performs the review.

31. The method of claim 30, wherein the third party is an outside expert resource.

32. The method of claim 20, wherein at least one participant casts a plurality of votes.

33. The method of claim 20, further comprising
causing the business entity to assign, in association with (E), an equity interest in the business entity to the participants that cast accepted votes.

34. The method of claim 33, wherein the equity interest comprises stock.

35. The method of claim 33, wherein the equity interest comprises stock options.

36. The method of claim 33, wherein the equity interest comprises stock discounts.

37. The method of claim 33, wherein at most a maximum number of votes are accepted.

38. The method of claim 20, further comprising
obtaining an agreement from the business entity that the business entity assign some interest in the business entity to the participants that cast accepted votes.

39. The method of claim 20, further comprising:
obtaining from the business entity a right to purchase an equity interest in the business entity; and
exercising the right to purchase to the benefit of the participants that cast accepted votes.

40. The method of claim 20, further comprising
causing value to be provided to the business entity.

41. The method of claim 40, wherein the value comprises the results of a review of the business entity.

42. The method of claim 40, further comprising
providing the value to the business entity.

43. The method of claim 40, wherein the value is provided by a third party.

44. The method of claim 43, wherein the third party is an outside expert resource.

45. A method comprising:
(A) presenting, to a plurality of participants, a conditional offer to provide the results of a review of a particular business entity;
subsequent to (A), receiving acceptances of the offer from at least one of the participants; and
subsequent to (A), causing the review of the business entity to be performed.

46. The method of claim 45, further comprising
deciding to cause the review to be performed based at least upon the number of acceptances received.

47. The method of claim 45, further comprising
performing the review.

48. A method comprising:
(A) accepting a vote from a participant; and
(B) receiving, in association with (A), compensation from the participant wherein value is provided to the participant in association with (A).

49. The method of claim 48, wherein the vote is cast by the participant in support of an activity.

50. The method of claim 48, wherein the value is provided by a third party.

51. The method of claim 48, further comprising
causing a third party to provide the value.

52. The method of claim 48, further comprising
providing the value.

53. The method of claim 48, wherein the value comprises the results of a review of a business entity.

54. A method comprising:
identifying a plurality of individuals;
receiving compensation from each of the individuals;
identifying a plurality of companies; and
providing, to each of the individuals, the results of a due diligence review of each of the companies.

55. A method comprising:
identifying a plurality of individuals; and
providing, to each of the individuals, an offer to provide, in exchange for compensation, the results of a due diligence review of each of a plurality of companies.

56. The method of claim 55, further comprising:
receiving an acceptance of the offer from each of the individuals;
receiving compensation from each of the individuals; and
providing, to each of the individuals, the results of a due diligence review of each of a plurality of companies.
